(19) United States
(12) Patent Application Publication
(10) Pub. No.: US 2012/0203363 A1
(43) Pub. Date: Aug. 9, 2012

(54) APPARATUS, SYSTEM AND METHOD FOR ACTIVATING FUNCTIONS IN PROCESSING DEVICES USING ENCODED AUDIO AND AUDIO SIGNATURES

(75) Inventors: WILLIAM JOHN MCKENNA, Columbia, MD (US); JOHN STAVROPOULOS, Edison, NJ (US); ALAN NEUHAUSER, Silver Spring, MD (US); JASON BOLLES, Highland, MD (US); JOHN KELLY, Westminster, MD (US); WENDELL LYNCH, East Lansing, MI (US)

(73) Assignee: ARBITRON, INC., Columbia, MD (US)

(21) Appl. No.: 13/341,272

(22) Filed: Dec. 30, 2011

Related U.S. Application Data
(63) Continuation-in-part of application No. 13/046,360, filed on Mar. 11, 2011.
Application No. 13/046,360 is a continuation of application No. 11/805,075, filed on May 21, 2007, now Pat. No. 7,908,133.
Application No. 11/805,075 is a continuation-in-part of application No. 10/256,834, filed on Sep. 27, 2002, now Pat. No. 7,222,071.
Application No. 10/256,834 is a continuation-in-part of application No. 13/307,649, filed on Nov. 30, 2011.

(51) Int. Cl. G06F 17/00

(52) U.S. Cl. 700/94

(57) ABSTRACT

Apparatus, system and method for accessing supplementary data and/or executing software on a device capable of receiving multimedia are disclosed. After multimedia is received, ancillary code is detected and a signature is concurrently extracted from an audio portion of the multimedia. The ancillary code includes a plurality of code symbols arranged in a plurality of layers in a predetermined time period, and the signature is extracted from features of the audio of the multimedia. Supplementary data is accessed and/or software is executed using the detected code an/or signature.

### RELATED APPLICATIONS

The present application is a continuation-in-part of U.S. non-provisional patent application Ser. No. 13/046,360 filed on Mar. 11, 2011, which is a continuation of U.S. Pat. No. 7,908,133, which is a continuation-in-part of U.S. Pat. No. 7,222,071. The present application is also a continuation-in-part of U.S. non-provisional patent application Ser. No. 13/307,649, to McKenna et al., titled “Apparatus, System and Method for Activating Functions in Processing Devices Using Encoded Audio,” filed Nov. 30, 2011. Each of these is assigned to the assignee of the present invention, and is hereby incorporated herein by reference in its entirety.

### BACKGROUND INFORMATION

There is considerable interest in identifying and/or measuring the receipt of, and or exposure to, audio data by an audience for use by advertisers, media outlets and others. The emergence of multiple, overlapping media distribution pathways, as well as the wide variety of available user systems (e.g. PC's, PDA's, portable CD players, Internet, cellular telephones, appliances, TV, radio, etc.) for receiving audio data, has greatly complicated the task of measuring audience receipt of, and exposure to, individual program segments. The development of commercially viable techniques for encoding audio data with program identification data provides a crucial tool for measuring audio data receipt and exposure across multiple media distribution pathways and user systems.

One such technique involves adding an ancillary code to the audio data that uniquely identifies the program signal. Most notable among these techniques is the PPM methodology developed by Arbitron Inc., which is already providing useful audience estimates to numerous media distributors and advertisers.

An alternative technique for identifying program signals is extraction and subsequent matching of “signatures” of the program signals. Such techniques typically involve the use of a reference signature database, which contains a reference signature for each program signal the receipt of which, and exposure to which, is to be measured. Before the program signal is broadcast, these reference signatures are created by measuring the values of certain features of the program signal and creating a feature set or “signature” from these values, commonly termed “signature extraction,” which is then stored in the database. Later, when the program signal is broadcast, signature extraction is again performed, and the signature obtained is compared to the reference signatures in the database until a match is found and the program signal is thereby identified.

Past designs of audience measurements systems, like that shown in U.S. Pat. No. 5,481,294 to Thomas et al., have comprised separate metering apparatuses comprising their own distinct code reading and signature extraction capability. Information obtained by each apparatus is then communicated to a central site for processing to produce audience measurement reports. These reports, based on the information obtained, provide data reflecting program exposure.

In obtaining information used in the generation of its reports, the above system is substantially reliant on low levels of background noise and hardwired connections to televisions and radios. Such constraints make use of the above system(s) impractical when unfettered portability of the metering apparatuses is desirable. Such portability thereof may be desirable in any given number of situations when, for example, connection to a device reproducing media, such as a television or radio, is not feasible, especially where it is desired to monitor out-of-home media exposure.

In a system like that shown in Thomas et al., the process of audience measurement is overly complicated by virtue of the use of multiple metering apparatuses. Because of such use, an excessive amount of power is consumed, so that the system is inefficient. It is particularly ill-suited for use in a portable metering device that must rely on an internal power source, such as a battery. In systems where audience measurement is an additional function of a device (such as a PDA or cellular telephone), it would be particularly advantageous to provide such functionality in the most efficient manner. To this end, it would be advantageous to minimize usage for this purpose of the processing power and working memory of the device to avoid slowing or otherwise interfering with additional capabilities offered by devices not dedicated to the task of audience measurement. Additionally, whether a portable metering device is or is not dedicated to the task of audience measurement, the power supply thereof, typically a battery, can be exhausted prematurely where excessive power is required to implement this function. Thus, it would be advantageous to provide the above-mentioned media monitoring capabilities while minimizing occurrence of the disadvantages discussed.

It would be advantageous to provide methods and systems for the gathering of data concerning the usage of media data that enable an audience member to undertake such activity no matter the situation or location in which media data is available. It would also be advantageous to provide such methods and systems which gather such data that are useful for determining exposure both to encoded and unencoded media, whether in-home or out-of-home, and which provide the ability to employ portable monitors that are small and unobtrusive and have low power requirements. It would further be advantageous to provide such methods and systems which gather such data by decoding ancillary codes and extracting signatures in an efficient manner reducing power and processing requirements. Additionally, detected codes codes can be used to streamline the collection of extracted signatures, while extracted signatures may be used to supplement code that may not contain complete information regarding audio that was received. Furthermore, if code can be detected concurrently with extracted signatures, both may be used to trigger actions on a processing device, such as activating a web link, presenting a digital picture, executing or activating an application (“app”), and so on.

### SUMMARY

The present disclosure relates to any device capable of producing research data relating to media and/or presenting media to a user including over-the-air, satellite or cable audio and/or video broadcasts, streaming video and/or audio, images, HyperText Markup Language (HTML) content, metadata, text, or any other visual and/or auditory indicia. Exemplary devices include cell phones, smart phones, personal digital assistants (PDAs), personal computers, portable computers, computer tablets, laptops, televisions, set-top boxes, media boxes, and the like.

For this application, the following terms and definitions shall apply:

The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of corresponding information in a different physical form or forms.

The terms “media data” and “media” as used herein mean data which is widely accessible, whether over-the-air, or via cable, satellite, network, internetwork (including the Internet), print, displayed, distributed on storage media, or by any other means or technique that is humanly perceptible, without regard to the form or content of such data, and including but not limited to audio, video, audio/video, text, images, animations, databases, broadcasts, displays (including but not limited to video displays, posters and billboards), signs, signals, web pages, print media and streaming media data.

The term “research data” as used herein means data comprising (1) data concerning usage of media data, (2) data concerning exposure to media data, and/or (3) market research data.

The term “presentation data” as used herein means media data or content other than media data to be presented to a user.

The term “ancillary code” as used herein means data encoded in, added to, combined with or embedded in media data to provide information identifying, describing and/or characterizing the media data, and/or other information useful as research data.

The terms “reading” and “read” as used herein mean a process or processes that serve to recover research data that has been added to, encoded in, combined with or embedded in, media data.

The term “database” as used herein means an organized body of related data, regardless of the manner in which the data or the organized body thereof is represented. For example, the organized body of related data may be in the form of one or more of a table, a map, a grid, a packet, a datagram, a frame, a file, an e-mail, a message, a document, a report, a list or in any other form.

The term “network” as used herein includes both networks and internetworks of all kinds, including the Internet, and is not limited to any particular network or inter-network.

The terms “first”, “second”, “primary” and “secondary” are used to distinguish one element, set, data, object, step, process, function, activity or thing from another, and are not used to designate relative position, or arrangement in time or relative importance, unless otherwise stated explicitly.

The terms “coupled”, “coupled to”, and “coupled with” as used herein each mean a relationship between or among two or more devices, apparatus, files, circuits, elements, functions, operations, processes, programs, media, components, networks, systems, subsystems, and/or means, constituting any one or more of (a) a connection, whether direct or through one or more other devices, apparatus, files, circuits, elements, functions, operations, processes, programs, media, components, networks, systems, subsystems, or means, (b) a communications relationship, whether direct or through one or more other devices, apparatus, files, circuits, elements, functions, operations, processes, programs, media, components, networks, systems, subsystems, or means, and/or (c) a functional relationship in which the operation of any one or more devices, apparatus, files, circuits, elements, functions, operations, processes, programs, media, components, networks, systems, subsystems, or means depends, in whole or in part, on the operation of any one or more others thereof.

The terms “communicate,” and “communicating” and as used herein include both conveying data from a source to a destination, and delivering data to a communications medium, system, channel, network, device, wire, cable, fiber, circuit and/or link to be conveyed to a destination and the term “communication” as used herein means data so conveyed or delivered. The term “communications” as used herein includes one or more of a communications medium, system, channel, network, device, wire, cable, fiber, circuit and link.

The term “processor” as used herein means processing devices, apparatus, programs, circuits, components, systems and subsystems, whether implemented in hardware or software, and whether or not programmable. The term “processor” as used herein includes, but is not limited to one or more computers, hardwired circuits, signal modifying devices and systems, devices and machines for controlling systems, central processing units, programmable devices and systems, field programmable gate arrays, application specific integrated circuits, systems on a chip, systems comprised of discrete elements and/or circuits, state machines, virtual machines, data processors, processing facilities and combinations of any of the foregoing.

The terms “storage” and “data storage” as used herein mean one or more data storage devices, apparatus, programs, circuits, components, systems, subsystems, locations and storage media serving to retain data, whether on a temporary or permanent basis, and to provide such retained data.

The terms “panelist,” “panel member,” “respondent,” “participant” and “user” are interchangeably used herein to refer to a person or individual from the general public who is, knowingly or unknowingly, participating in a study to gather information, whether by electronic, survey or other means, about that person's activity, and does not necessarily refer to a person that is participating in a study pursuant to a formal or informal agreement.

The term “activity” as used herein includes, but is not limited to, purchasing conduct, shopping habits, viewing habits, computer usage, Internet usage, exposure to media, personal attitudes, awareness, opinions and beliefs, as well as other forms of activity discussed herein.

The term “research device” as used herein shall mean (1) a portable user appliance configured or otherwise enabled to gather, store and/or communicate research data, or to cooperate with other devices to gather, store and/or communicate research data, (2) a research data gathering, storing and/or communicating device, and/or (3) a processing device, which may or may not be a portable user appliance, configured to perform an action based on collected research data.

The term “portable user appliance” (also referred to herein, for convenience, by the abbreviation “PUA”) as used herein means a device capable of being carried by or on the person of a user or capable of being disposed on or in, or held by, a physical object (e.g., attaché, purse) capable of being carried by or on the user, and having at least one function of primary benefit to such user, including without limitation, a cellular telephone, a personal digital assistant (“PDA”), a Blackberry device, a radio, a television, a game system (e.g., a Gameboy™ device), a notebook computer, a laptop computer, a tablet computer (e.g., an iPad™), a GPS device, a personal audio device (such as an MP3 player or an iPod™ device), a DVD player, a television including “smart televisions,” a two-way radio, a personal communications device, a telematics device, a remote control device, a wireless headset, a wristwatch, a portable data storage device (e.g., thumb-drive), a camera, a recorder, a keyless entry device, as well as any devices combining any of the foregoing or their functions.

The term “audience measurement” as used herein is understood in the general sense to mean techniques directed to determining and measuring media exposure, regardless of form, as it relates to individuals and/or groups of individuals from the general public. In some cases, reports are generated from the measurement; in other cases, no report is generated. Additionally, audience measurement includes the generation of data based on media exposure to allow audience interaction. By providing content or executing actions relating to media exposure, an additional level of sophistication may be introduced to traditional audience measurement systems, and further provide unique aspects of content delivery for users.

Portable meters are disclosed that implement an ability to read ancillary codes in audio media as well as an ability to extract signatures from audio media to gather information concerning media to which an audience member has been exposed, and perform actions based on that information. The meter carries out a transformation of received audio media data from a time domain to a frequency domain and makes use of the transformed audio media data both to read an ancillary code therein and to extract a signature therefrom. Since a common transformation may be used both for reading a code and for extracting a signature therefrom, the processing and working memory resources of the portable device required for implementing the functions of the audience meter are advantageously reduced. Likewise, the audience metering functionality thus imposes lower energy demands on the data processing and storage resources of the portable meter. Various apparatus, systems and methods are disclosed for decoding audio data for audience measurement purposes including an integrated system that provides an efficient and compact solution. The integrated system provides flexibility for installing audience measurement and audience interaction capabilities into various processing devices across numerous operating platforms.

In certain embodiments, computer-implemented methods are disclosed for a device configured to receive multimedia, comprising the steps of performing a transformation on a portion of the multimedia in the device, wherein the transformation detects ancillary code and extracts at least one signature from the portion; and performing an action in the device, wherein the action comprises one of (a) presenting supplementary data on the device, and (b) executing software on the device, wherein the action is determined from at least one of the ancillary code and extracted signature.

In certain embodiments, an apparatus is disclosed, comprising an interface for receiving multimedia on a device, wherein the multimedia comprises audio; and a processing apparatus, coupled to the interface, for performing a transformation on a portion of the multimedia in the device, wherein the transformation detects ancillary code and extracts at least one signature from the portion, wherein the processor is configured to perform an action in the device, wherein the action comprises one of (a) presenting supplementary data on the device, and (b) executing software on the device, wherein the action is determined from at least one of the ancillary code and extracted signature.

### BRIEF DESCRIPTION OF THE DRAWINGS

The present invention is illustrated by way of example and not limitation in the figures of the accompanying drawings, in which like references indicate similar elements and in which:

FIG. 1 is a functional block diagram for use in illustrating methods and systems for gathering research data;

FIG. 2 is a flow diagram for use in illustrating methods for gathering research data;

FIG. 3 is a functional block diagram of a system for gathering research data;

FIG. 4 is a diagram of a further system for gathering research data;

FIG. 4A is a functional block diagram for use in explaining certain embodiments of the system of FIG. 4;

FIG. 5 is a diagram of a further system for gathering research data;

FIG. 6 is a diagram illustrating a method of identifying research data gathered by one or more of the systems disclosed herein;

FIG. 7 is a diagram of a further system for gathering research data;

FIG. 8 is an exemplary embodiment of a system for decoding audio and obtaining supplemental information;

FIG. 9 is an exemplary message structure for decoding messages that may be suitable for obtaining supplemental information;

FIG. 10 illustrates an exemplary decoding process under one embodiment;

FIG. 11 is an exemplary flow chart illustrating a methodology for retrieving an information code from an encoded audio signal;

FIG. 12 is an exemplary flow chart illustrating another methodology for retrieving an information code from an encoded audio signal;

FIG. 13 illustrates a configuration for processing and retrieving supplementary information for codes and signatures under one embodiment; and

FIG. 14 illustrates an exemplary method for detecting codes and extracting signatures, and providing supplementary information relative to each.

### DETAILED DESCRIPTION

Various embodiments of the present invention will be described herein below with reference to the accompanying drawings. In the following description, well-known functions or constructions are not described in detail since they would obscure the invention in unnecessary detail.

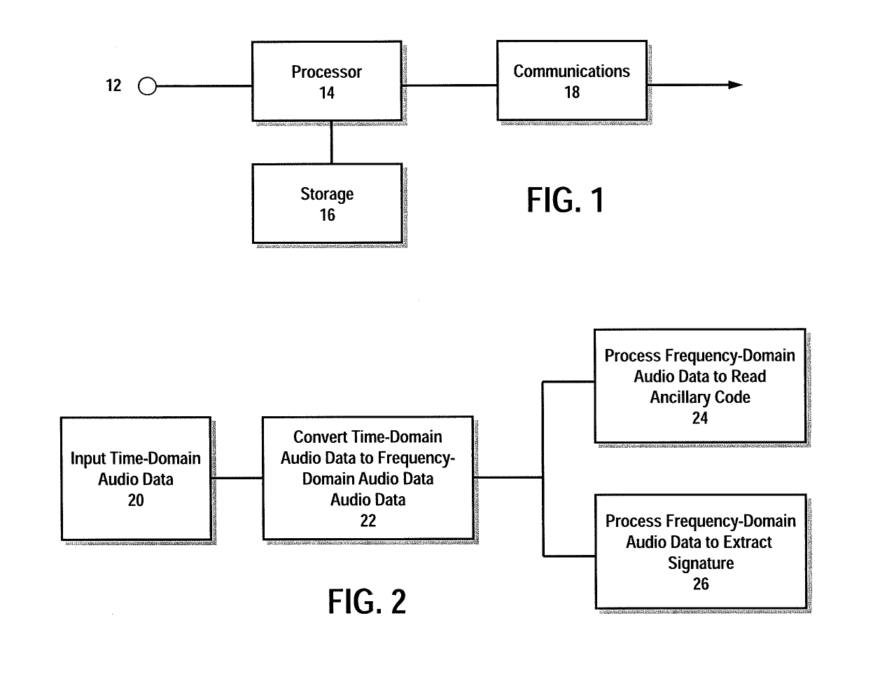

FIG. 1 is a diagram illustrating certain embodiments of a research data gathering system 10. A monitoring device 12 is provided for receiving monitored data and/or performing actions based on the monitored data. The monitoring device 12 can comprise either a single device or multiple devices, stationary at a source to be monitored, or multiple devices, stationary at multiple sources to be monitored. Alternatively, the monitoring device 12 can be incorporated in a portable monitoring device that can be carried by an individual to monitor various sources as the individual moves about.

Where acoustic data including media data, such as audio data, is monitored, the monitoring device 12 typically would be an acoustic transducer such as a microphone, having an input which receives media data in the form of acoustic energy and which serves to transduce the acoustic energy to electrical data. Where media data in the form of light energy, such as video data, is monitored, the monitoring device 12 takes the form of a light-sensitive device, such as a photodiode, or a video camera. Light energy including media data could be, for example, light emitted by a video display. The device 12 can also take the form of a magnetic pickup for sensing magnetic fields associated with a speaker, a capacitive pickup for sensing electric fields or an antenna for electromagnetic energy. In still other embodiments, the device 12 takes the form of an electrical connection to a monitored device, which may be a television, a radio, a cable converter, a satellite television system, a game playing system, a VCR, a DVD player, a portable player, a computer, a web appliance, or the like. In still further embodiments, the monitoring device 12 is embodied in monitoring software running on a computer to gather media data.

A processor 14, coupled to the monitoring device 12, is provided for processing the monitored data and performing actions based on the monitored data. Storage device 16, coupled to processor 14, receives data from the processor 14 for storage. Communications 18 is coupled with the processor 14 and is provided for communicating the processed data to a processing facility for use in preparing reports including research data. Additionally, communications 18 is configured to transmit and/or receive executable instructions or data for performing actions, and may also receive content or other data related to an action

FIG. 2 is a diagram for use in explaining operation of certain embodiments of the system of FIG. 1. As shown at 20, time-domain audio data is received by the monitoring device 12. Once received, the time-domain audio data, representing the audio signal as it varies over time, is converted by processor, as shown at 22, to frequency-domain audio data, i.e., data representing the audio signal as it varies with frequency. As will be understood by one of ordinary skill in the art, conversion from the time domain to the frequency domain may be accomplished by any one of a number of existing techniques comprising, for instance, discrete Fourier transform, fast Fourier transform (FFT), DCT, wavelet transform, Hadamard transform or other time-to-frequency domain transformation, or else by digital or analog filtering. Processor 14 stores the frequency-domain audio data temporarily in storage 16.

Processor 14 processes the frequency-domain audio data to read an ancillary code therefrom, as shown at 24, as well as to extract a signature therefrom, i.e., data expressing information inherent to an audio signal, as shown at 26, for use in identifying the audio signal or obtaining other information concerning the audio signal (such as a source or distribution path thereof).

Where audio media includes ancillary codes, suitable decoding techniques are employed to detect the encoded information, such as those disclosed in U.S. Pat. No. 5,450,490 and U.S. Pat. No. 5,764,763 to Jensen, et al., U.S. Pat. No. 5,579,124 to Aijala, et al., U.S. Pat. Nos. 5,574,962, 5,581,800 and 5,787,334 to Fardeau, et al., U.S. Pat. No. 6,871,180 to Neuhauser, et al., U.S. Pat. No. 6,862,355 to Kolessar, et al., U.S. Pat. No. 6,845,360 to Jensen, et al., U.S. Pat. No. 5,319,735 to Preuss et al., U.S. Pat. No. 5,687,191 to Lee, et al., U.S. Pat. No. 6,175,627 to Petrovich et al., U.S. Pat. No. 5,828,325 to Wolosewicz et al., U.S. Pat. No. 6,154,484 to Lee et al., U.S. Pat. No. 5,945,932 to Smith et al., US 2001/0053190 to Srinivasan, US 2003/0110485 to Lu, et al., U.S. Pat. No. 5,737,025 to Dougherty, et al., US 2004/0170381 to Srinivasan, and WO 06/14362 to Srinivasan, et al., all of which hereby are incorporated by reference herein.

Examples of techniques for encoding ancillary codes in audio, and for reading such codes, are provided in Bender, et al., “Techniques for Data Hiding”, IBM Systems Journal, Vol. 35, Nos. 3 & 4, 1996, which is incorporated herein by reference in its entirety. Bender, et al. disclose a technique for encoding audio termed “phase encoding” in which segments of the audio are transformed to the frequency domain, for example, by a discrete Fourier transform (DFT), so that phase data is produced for each segment. Then the phase data is modified to encode a code symbol, such as one bit. Processing of the phase encoded audio to read the code is carried out by synchronizing with the data sequence, and detecting the phase encoded data using the known values of the segment length, the DFT points and the data interval.

Bender, et al. also describe spread spectrum encoding and decoding, of which multiple embodiments are disclosed in the above-cited Aijala, et al. U.S. Pat. No. 5,579,124. Still another audio encoding and decoding technique described by Bender, et al. is echo data hiding in which data is embedded in a host audio signal by introducing an echo. Symbol states are represented by the values of the echo delays, and they are read by any appropriate processing that serves to evaluate the lengths and/or presence of the encoded delays. A further technique, or category of techniques, termed “amplitude modulation” is described in R. Walker, “Audio Watermarking”, BBC Research and Development, 2004. In this category fall techniques that modify the envelope of the audio signal, for example by notching or otherwise modifying brief portions of the signal, or by subjecting the envelope to longer term modifications. Processing the audio to read the code can be achieved by detecting the transitions representing a notch or other modifications, or by accumulation or integration over a time period comparable to the duration of an encoded symbol, or by another suitable technique.

Another category of techniques identified by Walker involves transforming the audio from the time domain to some transform domain, such as a frequency domain, and then encoding by adding data or otherwise modifying the transformed audio. The domain transformation can be carried out by a Fourier, DCT, Hadamard, Wavelet or other transformation, or by digital or analog filtering. Encoding can be achieved by adding a modulated carrier or other data (such as noise, noise-like data or other symbols in the transform domain) or by modifying the transformed audio, such as by notching or altering one or more frequency bands, bins or combinations of bins, or by combining these methods. Still other related techniques modify the frequency distribution of the audio data in the transform domain to encode. Psychoacoustic masking can be employed to render the codes inaudible or to reduce their prominence. Processing to read ancillary codes in audio data encoded by techniques within this category typically involves transforming the encoded audio to the transform domain and detecting the additions or other modifications representing the codes.

A still further category of techniques identified by Walker involves modifying audio data encoded for compression (whether lossy or lossless) or other purpose, such as audio data encoded in an MP3 format or other MPEG audio format, AC-3, DTS, ATRAC, WMA, RealAudio, Ogg Vorbis, APT X100, FLAC, Shorten, Monkey's Audio, or other. Encoding involves modifications to the encoded audio data, such as modifications to coding coefficients and/or to predefined decision thresholds. Processing the audio to read the code is carried out by detecting such modifications using knowledge of predefined audio encoding parameters.

It will be appreciated that various known encoding techniques may be employed, either alone or in combination with the above-described techniques. Such known encoding techniques include, but are not limited to FSK, PSK (such as BPSK), amplitude modulation, frequency modulation and phase modulation.

In certain embodiments, certain encoding techniques, such as those described in U.S. Pat. No. 6,871,180 to Neuhauser, et al., disclose audio encoding techniques that encode audio with one or more continuously repeating messages, each including a number of code symbols following one after the other along a time base of the audio signal. Each code symbol comprises a plurality of frequency components. In certain embodiments of system 10 that are adapted to read continuously repeating messages, acoustic energy, or, sound, picked up by the monitoring device 12 is continuously monitored to detect the embedded symbols comprising an encoded message. That is, decoding of an encoded message in the audio signal occurs continuously throughout operation of the system 10. In doing so, system 10 performs an FFT by means of processor 14 which is carried out on a continuing basis transforming a time segment of the audio signal to the frequency domain. In certain ones of such embodiments, a segment thereof comprising a one-quarter second duration is transformed to the frequency domain using an FFT, such that the segments overlap by, for example, 40%, 50%, 60%, 70% or 80%. System 10 separately evaluates for each component of the frequency code symbols in the encoded message whether the received energy comprises either a message or noise first by formulating a quotient comprising an associated energy value of a given frequency bin that would indicate such frequency components relative to a noise level associated with neighboring frequency bins. The noise level is obtained by averaging the energy levels of a predetermined number of frequency ranges neighboring the selected frequency bin being evaluated.

Storage 16 implements one or more accumulators for storage of the quotients associated with varying portions of the audio signal. Storage 16, for instance comprising a first-in/first-out (FIFO) buffer, enables each of the quotients to be continuously, repeatedly accumulated and sorted according to predetermined criteria. Such criteria comprises, optionally, a message length equal to that of the accumulator. Accordingly, where there are multiple messages simultaneously present in the audio, each accumulator serves to accumulate the frequency components of the code symbols in a respective one of the messages. In certain ones of these embodiments, multiple messages are detected as disclosed in U.S. Pat. No. 6,845,360 to Jensen, et al. Accumulation of the messages in this manner comprises an advantage of reducing the influence of noise which factors into the reading of the message.

As explained above, signatures are formed from the same audio data in the frequency domain that is used to decode the encoded messages in the audio. Suitable techniques for extracting signatures include those disclosed in U.S. Pat. No. 5,612,729 to Ellis, et al. and in U.S. Pat. No. 4,739,398 to Thomas, et al., each of which is assigned to the assignee of the present application and both of which are incorporated herein by reference in their entireties. Still other suitable techniques are the subject of U.S. Pat. No. 2,662,168 to Scherbatskoy, U.S. Pat. No. 3,919,479 to Moon, et al., U.S. Pat. No. 4,697,209 to Kiewit, et al., U.S. Pat. No. 4,677,466 to Lert, et al., U.S. Pat. No. 5,512,933 to Wheatley, et al., U.S. Pat. No. 4,955,070 to Welsh, et al., U.S. Pat. No. 4,918,730 to Schulze, U.S. Pat. No. 4,843,562 to Kenyon, et al., U.S. Pat. No. 4,450,551 to Kenyon, et al., U.S. Pat. No. 4,230,990 to Lert, et al., U.S. Pat. No. 5,594,934 to Lu, et al., European Published Patent Application EP 0887958 to Bichsel, PCT Publication WO02/11123 to Wang, et al. and PCT publication WO91/11062 to Young, et al., all of which are incorporated herein by reference in their entireties.

It is contemplated that system 10 comprise software and/or hardware enabling the extraction of signatures from received audio signals. The software is configured to direct the processor 14 to retain the time at which a particular signature is extracted, and to direct storage thereof in storage 16. The signatures gathered by system 10 are communicated by communications 18 to a processing facility for matching with reference signatures for identifying the broadcast audio signal, or portion thereof.

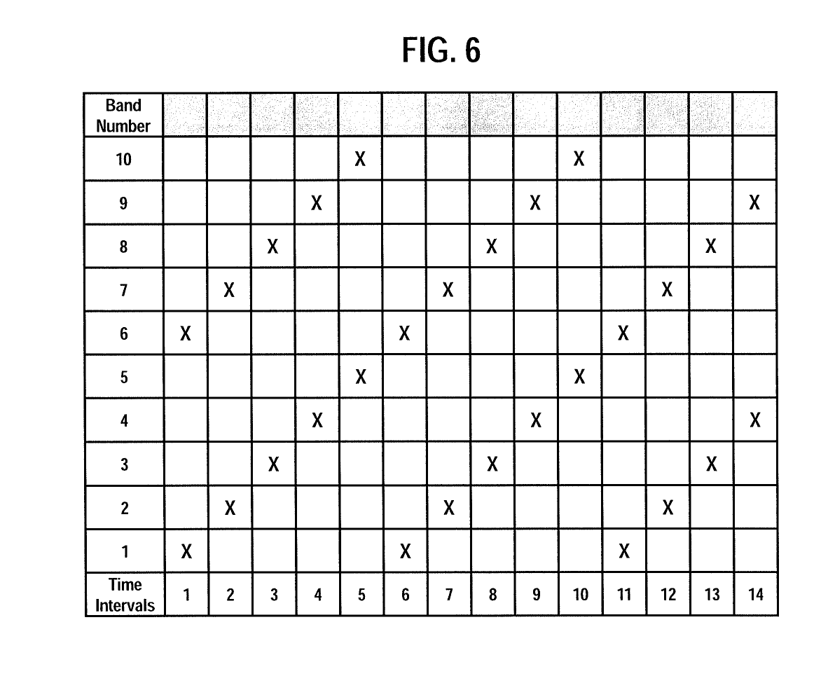

In certain embodiments, when using data resulting from an FFT performed across a predetermined frequency range, the FFT data from an even number of frequency bands (for example, eight, ten, sixteen or thirty two frequency bands) spanning the predetermined frequency range are used two bands at a time during successive time intervals. FIG. 6 provides an example of how pairs of the bands are selected in these embodiments during successive time intervals where the total number of bands used is equal to ten. The selected bands are indicated by an “X”.

When each band is selected, the energy values of the FFT bins within such band and such time interval are processed to form one bit of the signature. If there are ten FFT's for each time interval of the audio signal, for example, the values of all bins of such band within the first five FFT's are summed to form a value “A” and the values of all bins of such band within the last five FFT's are summed to form a value “B”. In the case of a received broadcast audio signal, the value A is formed from portions of the audio signal that were broadcast prior to those used to form the value B or which represent earlier portions of the audio signal relative to its time base.

To form a bit of the signature, the values A and B are compared. If B is greater than A, the bit is assigned a value “1” and if A is greater than or equal to B, the bit is assigned a value of “0”. Thus, during each time interval, two bits of the signature are produced. Each bit of the signature is a representation of the energy content in the band represented thereby during a predetermined time period, and may be referred to as the “energy slope” thereof. Because any one energy slope is associated with a particular band, as opposed to being associated with a representation of energy content across a group of bands or between certain ones of various bands, the impact of fluctuations in the relative magnitudes of reproduced audio among frequency bands is virtually eliminated.

In certain embodiments, signatures are extracted continuously. In such embodiments, information is obtained without a dependency on a triggering, predetermined event, or other type of prompting, and thus through uninterrupted information gathering, the signatures obtained will, necessarily, contain more information. For instance, this additional information is manifested in a signature, or portion thereof, that is formed of information as to how the audio signal changes over time as well as with frequency. This is in contrast to signature extraction occurring only upon prompting caused by a predetermined event and detection thereof, whereby information then obtained is only representative of the audio signal characterized within a certain isolated time frame.

Typically, frequency bins or bands of different size are employed to extract signatures and read codes. For example, relatively narrow bin sizes, such as 2, 4 or 6 Hz are used to detect the presence of a component of an ancillary code, while signature extraction requires the use of wider bands, such as 30, 40 or 60 Hz to ensure that the band energy is sufficient to permit the extraction of a reliable signature or signature portion. Accordingly, in an advantageous embodiment of the invention that employs a time domain-to-frequency domain transformation that distributes the energy of an audio signal into a plurality of frequency bins or bands, the size or sizes of the bins or bands are each selected to have a first, relatively narrow frequency width. The energy values of such frequency bins or bands are processed to read an ancillary code therefrom. These energy values are also combined in groups of contiguous bins or bands (such as by addition) to produce frequency band values each representing an energy level within a frequency band comprising the respective group. Such frequency band values are then processed to extract a signature therefrom.

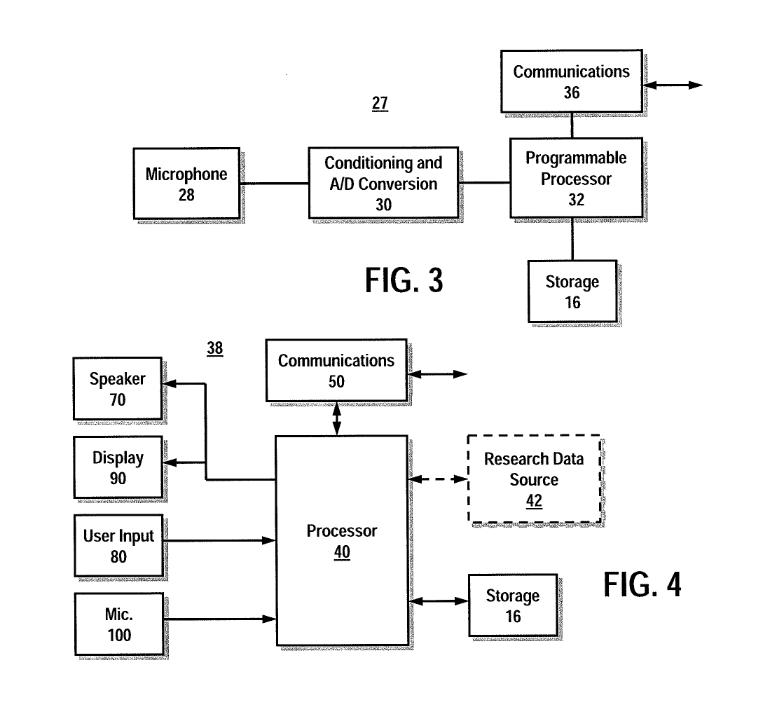

With reference to FIG. 3, which illustrates at least one of certain advantageous embodiments of the system, a PUA 27 is shown which is configured for gathering research data. Audio data is received at the microphone 28, which may also comprise a peripheral of the PUA 27 allowing it to be located a distance from the remainder thereof should doing so provide added convenience to the user. The audio data is then conditioned and converted from its analog format to digital data, as shown at 30, in a manner understood by one of ordinary skill in the art. A programmable processor 32 coupled with the system then transforms the digital data to the frequency domain, optionally by DFT, FFT or other transform technique including DCT, wavelet transform, Hadamard transform, or else by digital or analog filtering. The PUA 27 further comprises storage 34, comprising a buffer such as a FIFO buffer addressed herein, for cooperation with the processor 32 in a manner well understood by one of ordinary skill in the art, to both decode an ancillary code and extract a signature from the single data set produced by, for example, an FFT. Communications 36 receives data processed by the processor 32 and is coupled thereto for delivery to a remote processing location. In certain embodiments, storage 34 serves to retain information not immediately transmitted to communications 36.

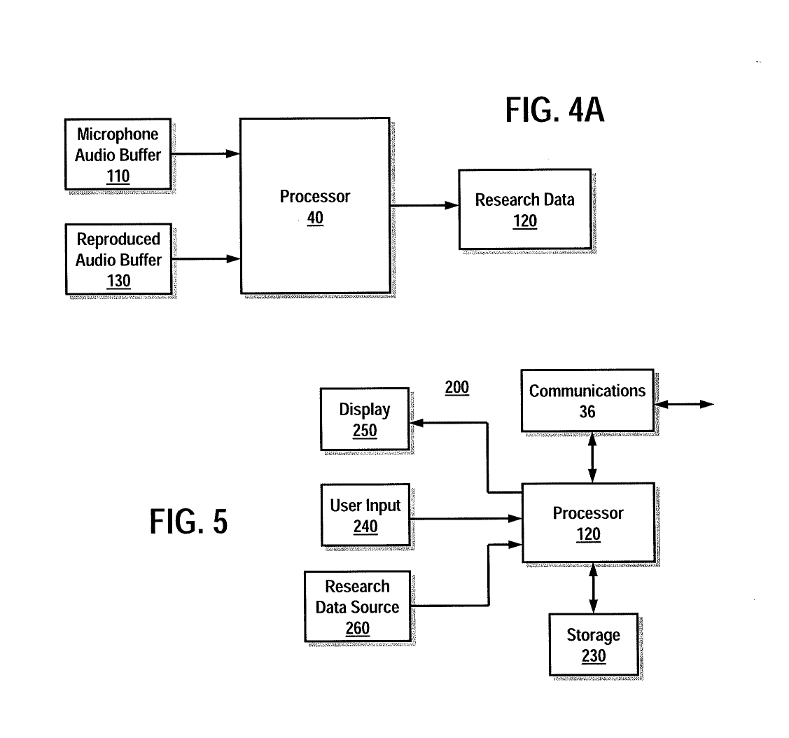

With reference to FIGS. 4 and 4A, there is illustrated a block diagram of a cellular telephone 38 modified to carry out a research operation which may include measuring media exposure as well as performing an action based on the media exposure. The cellular telephone 38 comprises a processor 40 operative to exercise overall control of the cellular telephone's operation and to process audio and other data for transmission or reception. Communications 50 is coupled to the processor 40 and is operative to establish and maintain a two-way wireless communication link with a respective cell of a cellular telephone network. In certain embodiments, processor 40 is configured to execute applications apart from or in conjunction with the conduct of cellular telephone communications, such as applications serving to download audio and/or video data to be reproduced by the cellular telephone, e-mail clients and applications enabling the user to play games using the cellular telephone. In certain embodiments, processor 40 comprises two or more processing devices, such as a first processing device (such as a digital signal processor) that processes audio, and a second processing device that exercises overall control over operation of the cellular telephone. In certain embodiments, processor 40 comprises a single processing device. In certain embodiments, some or all of the functions of processor are implemented by hardwired circuitry.

Cellular telephone 38 further comprises storage 60 coupled with processor 40 and operative to store data as needed. In certain embodiments, storage 60 comprises a single storage device, while in others it comprises multiple storage devices. In certain embodiments, a single device implements certain functions of both processor 40 and storage 60. In addition, cellular telephone 38 comprises a microphone 100 coupled with processor 40 and serving to transduce the user's voice to an electrical signal which it supplies to processor 40 for encoding, and a speaker and/or earphone 70 coupled with processor 40 to transduce received audio from processor 40 to an acoustic output to be heard by the user. Cellular telephone 38 also includes a user input 80 coupled with processor 40, such as a keypad, to enter telephone numbers and other control data, as well as a display 90 coupled with processor 40 to provide data visually to the user under the control of processor 40.

In certain embodiments, cellular telephone 38 provides additional functions and/or comprises additional elements. In certain ones of such embodiments, the cellular telephone 38 provides e-mail, text messaging and/or web access through its wireless communications capabilities, providing access to media and other content. For example, Internet access via cellular telephone 38 enables access to video and/or audio content that can be reproduced by the cellular telephone 38 for the user, such as songs, video on demand, video clips and streaming media. In certain embodiments, storage 60 stores software providing audio and/or video downloading and reproducing functionality, such as iPod™ software, enabling the user to reproduce audio and/or video content downloaded from a source, such as a personal computer via communications 50 or through direct Internet access via communications 50.

To enable cellular telephone 38 to gather research data, namely, data indicating exposure to audio such as programs, music and advertisements, research software is installed therein to control processor 40 to gather such data and communicate it via communications 50 to a research organization. The research software in certain embodiments also controls processor 40 to store the data in storage 60 for subsequent communication.

The research software controls the processor 40 to transduce the time-domain audio data produced by microphone 100 to frequency domain data and to read ancillary codes from the frequency domain data using one or more of the known techniques identified hereinabove, and then to store and/or communicate the codes that have been read for use as research data indicating encoded audio to which the user was exposed. The research software also controls the processor 40 to extract signatures from the frequency domain data using one or more of the known techniques identified hereinabove, and then to store and/or communicate the extracted signature data for use as research data which is then matched with reference signatures representing known audio to detect the audio to which the user was exposed. In certain embodiments, the research software controls the processor 40 to store samples of the transduced audio, either in compressed or uncompressed form for subsequent processing to read ancillary codes therein and to extract signatures therefrom after transformation to the frequency domain. In certain embodiments, the research software is operative both to read codes and extract signatures from the audio data, and selectively (a) both reads such codes and extracts such signatures from certain portions of the audio data and/or (b) reads codes from certain portions of the audio data and extracts signatures from other portions of the audio data.

Where the cellular telephone 38 possesses functionality to download and/or reproduce presentation data, in certain embodiments, research data concerning the usage and/or exposure to such presentation data as well as audio data received acoustically by microphone 100, is gathered by cellular telephone 38 in accordance with the technique illustrated by the functional block diagram of FIG. 4A. Storage 60 of FIG. 4 implements an audio buffer 110 for audio data gathered with the use of microphone 100. In certain ones of these embodiments storage 60 implements a buffer 130 for presentation data downloaded and/or reproduced by cellular telephone 38 to which the user is exposed via speaker and/or earphone 70 or display 90, or by means of a device coupled with cellular telephone 38 to receive the data therefrom to present it to a user. In some of such embodiments, the reproduced data is obtained from downloaded data, such as songs, web pages or audio/video data (e.g., movies, television programs, video clips). In some of such embodiments, the reproduced data is provided from a device such as a broadcast or satellite radio receiver of the cellular telephone 38 (not shown for purposes of simplicity and clarity). In certain ones of these embodiments storage 60 implements a buffer 130 for metadata of presentation data reproduced by cellular telephone 38 to which the user is exposed via speaker and/or earphone 70 or display 90, or by means of a device coupled with cellular telephone 38 to receive the data therefrom to present it to a user. Such metadata can be, for example, a URL from which the presentation data was obtained, channel tuning data, program identification data, an identification of a prerecorded file from which the data was reproduced, or any data that identifies and/or characterizes the presentation data, or a source thereof. Where buffer 130 stores audio data, buffers 110 and 130 store their audio data (either in the time domain or the frequency domain) independently of one another. Where buffer 130 stores metadata of audio data, buffer 110 stores its audio data (either in the time domain or the frequency domain) and buffer 130 stores its metadata, each independently of the other.

Processor 40 separately produces research data 120 from the contents of each of buffers 110 and 130 which it stores in storage 60. In certain ones of these embodiments, one or both of buffers 110 and 130 is/are implemented as circular buffers storing a predetermined amount of time-domain audio data representing a most recent time interval thereof as received by microphone 100 and/or reproduced by speaker and/or earphone 70, or downloaded by cellular telephone 38 for reproduction by a different device coupled with cellular telephone 38. Processor 40 extracts signatures and/or decodes ancillary codes in the buffered audio data to produce research data 120 by converting the time-domain audio data to frequency-domain audio data and processing the frequency-domain audio data for reading an ancillary code therefrom and extracting a signature therefrom. Where metadata is received in buffer 130, in certain embodiments the metadata is used, in whole or in part, as research data, or processed to produce research data. The research data is thus gathered representing exposure to and/or usage of audio data by the user where audio data is received in acoustic form by the cellular telephone 38 and where presentation data is received in non-acoustic form (for example, as a cellular telephone communication, as an electrical signal via a cable from a personal computer or other device, as a broadcast or satellite signal or otherwise).

With reference again to FIG. 4, in certain embodiments, the cellular telephone 38 comprises a research data source 42 coupled by a wired or wireless coupling with processor 40 for use in gathering further or alternative research data to be communicated to a research organization. In certain ones of these embodiments, the research data source 42 comprises a location data producing device or function providing data indicating a location of the cellular telephone 38. Various devices appropriate for use as the research data source 42 include a satellite location signal receiver, a terrestrial location signal receiver, a wireless networking device that receives location data from a network, an inertial location monitoring device and a location data producing service provided by a cellular telephone service provider. In certain embodiments, research data source 42 comprises a device or function for monitoring exposure to print media, for determining whether the user is at home or out of home, for monitoring exposure to products, exposure to displays (such as outdoor advertising), presence within or near commercial establishments, or for gathering research data (such as consumer attitude, preference or opinion data) through the administration of a survey to the user of the cellular telephone 38. In certain embodiments, research data source 42 comprises one or more devices for receiving, sensing or detecting data useful in implementing one or more of the foregoing functions, other research data gathering functions and/or for producing data ancillary to functions of gathering, storing and/or communicating research data, such as data indicating whether the panelist has complied with predetermined rules governing the activity or an extent of such compliance. Such devices include, but are not limited to, motion detectors, accelerometers, temperature detectors, proximity detectors, satellite positioning signal receivers, RFID readers, RF receivers, wireless networking transceivers, wireless device coupling transceivers, pressure detectors, deformation detectors, electric field sensors, magnetic field sensors, optical sensors, electrodes, and the like.

With reference to FIG. 5, there is illustrated a personal digital assistant (PDA) 200 modified to gather research data. The PDA 200 comprises a processor 210 operative to exercise overall control and to process data for, among other purposes, transmission or reception by the PDA 200. Communications 220 is coupled to the processor 210 and is operative under the control of processor 210 to perform those functions required for establishing and maintaining two-way communications over a network (not shown for purposes of simplicity and clarity).

In certain embodiments, processor 210 comprises two or more processing devices, such as a first processing device that controls overall operation of the PDA 200 and a second processing device that performs certain more specific operations such as digital signal processing. In certain embodiments, processor 210 employs a single processing device. In certain embodiments, some or all of the functions of processor 210 are implemented by hardwired circuitry. PDA 200 further comprises storage 230 coupled with processor 210 and operative to store software that runs on processor 210, as well as temporary data as needed. In certain embodiments, storage 230 comprises a single storage device, while in others it comprises multiple storage devices. In certain embodiments, a single device implements certain functions of both processor 210 and storage 230.

PDA 200 also includes a user input 240 coupled with processor 210, such as a keypad, to enter commands and data, as well as a display 250 coupled with processor 210 to provide data visually to the user under the control of processor 210. In certain embodiments, the PDA 200 provides additional functions and/or comprises additional elements. In certain embodiments, PDA 200 provides cellular telephone functionality, and comprises a microphone and audio output (not shown for purposes of simplicity and clarity), as well as an ability of communications 220 to communicate wirelessly with a cell of a cellular telephone network, to enable its operation as a cellular telephone. Where PDA 200 possesses cellular telephone functionality, in certain embodiments PDA 200 is employed to gather, store and/or communicate research data in the same manner as cellular telephone 38 (such as by storing appropriate research software in storage to run on processor), and communicates with system 10 in the same manner to set up, promote, operate, maintain and/or terminate a research operation using PDA 200.

In certain embodiments, communications 220 of PDA 200 provides wireless communications via Bluetooth protocol, ZigBee™ protocol, wireless LAN protocol, infrared data link, inductive link or the like, to a network, network host or other device, and/or through a cable to such a network, network host or other device. In such embodiments, PDA 200 is employed to gather, store and/or communicate research data in the same manner as cellular telephone 38 (such as by storing appropriate research software in storage to run on processor), and communicates with system 10 in the same manner (either through a wireless link or through a connection, such as a cable) to set up, promote, operate, maintain and/or terminate a research operation using PDA 200.

PDA 200 receives audio data in the form of acoustic data and/or audio data communicated in electronic form via a wireless or wired link. PDA stores research software enabling PDA 200 to gather research data, namely, data indicating exposure to such audio data, by controlling processor 210 to gather such data and communicate it via communications 220 to a research organization. The research software in certain embodiments also controls processor 210 to store the data in storage 230 for subsequent communication. That is, processor 210 is controlled to read codes from the audio data and extract signatures therefrom in the same manner as any one or more of the embodiments explained hereinabove.

In certain embodiments, the PDA 200 comprises a research data source 260 coupled by a wired or wireless coupling with processor 210 for use in gathering further or alternative research data to be communicated to a research organization. In certain ones of these embodiments, the research data source 260 comprises a location data producing device or function providing data indicating a location of the cellular telephone PDA 200. Various devices appropriate for use as source include a satellite location signal receiver, a terrestrial location signal receiver, a wireless networking device that receives location data from a network, an inertial location monitoring device and a location data producing service provided by a cellular telephone service provider. In certain ones of these embodiments, research data source 260 comprises a device or function for monitoring exposure to print media, for determining whether the user is at home or out of home, for monitoring exposure to products, exposure to displays (such as outdoor advertising), presence within or near commercial establishments, or for gathering research data (such as consumer attitude, preference or opinion data) through the administration of a survey to the user of the PDA 200. In certain ones of these embodiments, research data source comprises one or more devices for receiving, sensing or detecting data useful in implementing one or more of the foregoing functions, other research data gathering functions and/or for producing data ancillary to functions of gathering, storing and/or communicating research data, such as data indicating whether the panelist has complied with predetermined rules governing the activity or an extent of such compliance. Such devices include, but are not limited to, motion detectors, accelerometers, temperature detectors, proximity detectors, satellite positioning signal receivers, RFID readers, RF receivers, wireless networking transceivers, wireless device coupling transceivers, pressure detectors, deformation detectors, electric field sensors, magnetic field sensors, optical sensors, electrodes, and the like.

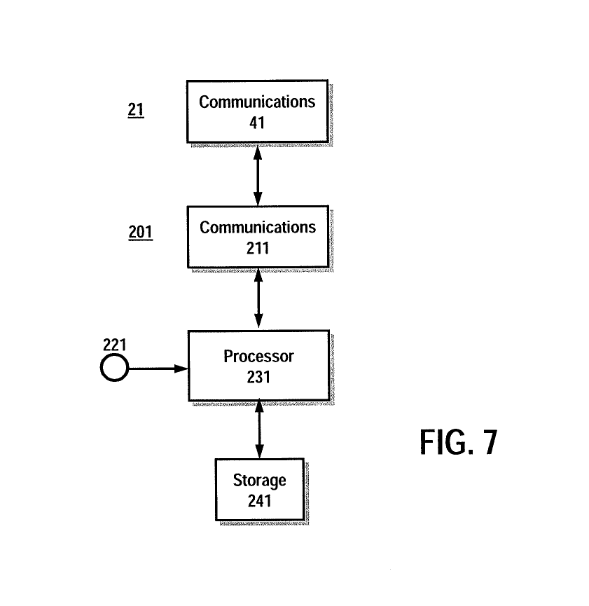

FIG. 7 illustrates a PUA 21 coupled by its communications 41 with communications 211 of a research system 201 comprising a microphone 221, a processor 231 coupled with microphone 221 and with communications 211 by a wired or wireless link. Research system 201 in certain embodiments comprises storage 241 coupled with processor 231. In certain embodiments, communications 41 is operative to communicate data to a research data processing facility. In certain embodiments, communications 41 is further operative to communicate data with the research system 201. Such communications between the PUA 21 and research system 201 may be triggered by, for example, either (1) the elapse of a predetermined interval of time, (2) production of a communications request or query by either the PUA 21 or the research system 201, (3) the storage of a predetermined amount of data by either PUA 21 and/or research system 201, (4) proximity of PUA 21 and the research system 201, or (5) any combination of (1)-(4). In certain embodiments, communications 41 of PUA 21 comprises a transceiver configured to communicate using a Bluetooth protocol, ZigBee™ protocol, wireless LAN protocol, or via an infrared data link, inductive link or the like, for enabling communications with the research system 201 as well as with a network, network host or other device to communicate data to a research data processing facility. In certain embodiments, communications 41 of PUA 21 comprises a first transceiver configured to communicate with research system 201 and a second transceiver (such as a cellular telephone transceiver) configured to communicate with the research data processing facility.

In certain embodiments research system 201 is housed separately from PUA 21 and is physically separated therefrom, but both are carried on the person of a panelist. In certain embodiments, research system 201 is housed separately from PUA 21 but is either (1) affixed to an exterior surface thereof, (2) carried by or in a common container or carriage device with PUA 21, (3) carried by or in a cover of PUA 21 (such as a decorative “skin”), or (4) arranged to contain PUA 21. In certain embodiments, PUA 21 and research system 201 are contained by a common housing. In certain ones of such embodiments, processor 231 of research system 201 serves to read ancillary codes and extract signatures from audio data transduced by the microphone 221 in the manner described above in connection with the embodiments of FIGS. 1 through 5. Certain ones of these embodiments communicate the ancillary codes that have been read and the signatures that have been extracted to the PUA 21 by communications 211 for storage and/or communication from the PUA.

In certain ones of these embodiments, storage 241 serves to store the ancillary codes and/or signatures for subsequent communication to the PUA 21. In certain ones of such embodiments, research system 201 serves to store audio data transduced by the microphone 221 in storage 241, and subsequently communicates the audio data to PUA 21 via communications 211. PUA 21 processes the audio data as described hereinabove to produce research data therefrom. In certain ones of such embodiments, research system 201 receives audio data from PUA 21 via communications 211 and processor 231 serves to produce research data from the audio data which either is stored in storage 241 and subsequently communicated to PUA 21 by communications 211 or communicated thereby without prior storage in research system 201.

In certain ones of such embodiments, processor 231 of research system 201 receives presentation data and/or metadata of the presentation data from PUA 21 via communications 211 and processes the presentation data and/or metadata to produce research data therefrom. Such presentation data and metadata is received by PUA 21 in a form other than acoustic data such as electrical or electromagnetic data. Research system 201 either stores such research data in storage 241 and subsequently communicates it to PUA 21 by communications 211, or communicates the research data to PUA 21 by communications 211 without prior storage in research system 201. In certain embodiments of research system 201, processor 231 adds a time and/or date stamp to research data, media data, presentation data or metadata of one of the foregoing received, produced, stored or communicated thereby.

In certain ones of such embodiments, research system 201 receives audio data, presentation data and/or metadata of one of the foregoing from PUA 21 via communications 211 and stores the received data in storage 241. Subsequently, system 201 reads the stored data from storage 241 and communicates it to PUA 21 which either processes it to produce research data therefrom or communicates it to a processing facility for producing research data. Communication of the research data from the PUA 21 affords a number of advantages. At least a first advantage includes being able to provide a user a research system of smaller size and lower weight since (1) it need not itself comprise hardware enabling communication of the research data to the processing facility, (2) a smaller power source, commonly a battery, thus decreasing the size and weight of the research system may be used for operation thereof, and (3) less data storage capacity is necessary in the research system given the opportunity for frequent communication of research data between the PUA 21 and the research system 201. At least a second advantage includes an opportunity for increased frequency of reporting of the research data to the research data processing facility since the PUA 21 is readily available for the communication thereof.

In certain ones of the foregoing embodiments, PUA 21 gathers media data research data from media data received thereby in non-acoustic form and/or metadata of such media data. PUA 21 either stores such media data research data and later communicates it to a research organization via communications 41, or communicates it without first storing it. In certain ones of such embodiments, PUA 21 receives audio data research data from system 201 produced thereby from audio data, and communicates the audio data research data to a research organization via communications 41. In certain ones of such embodiments, PUA 21 combines the audio data research data and the media data research data for communication to a research organization via communications 41.

Embodiments disclosing various configurations for a research data monitor, as well as a research data monitor operatively coupled with a PUA is disclosed in U.S. Pat. No. 7,908,133 and is incorporated by reference herein. Research software for the research data monitor and/or PUA is provided to those of the foregoing devices implementing research operations by means of programmed processors. In certain embodiments, the research software is stored at the time of manufacture. In others, it is installed subsequently, either by a distributor, retailer, user, service provider, research organization or other entity by download to the respective device or by installation of a storage device storing the research software as firmware, or otherwise.

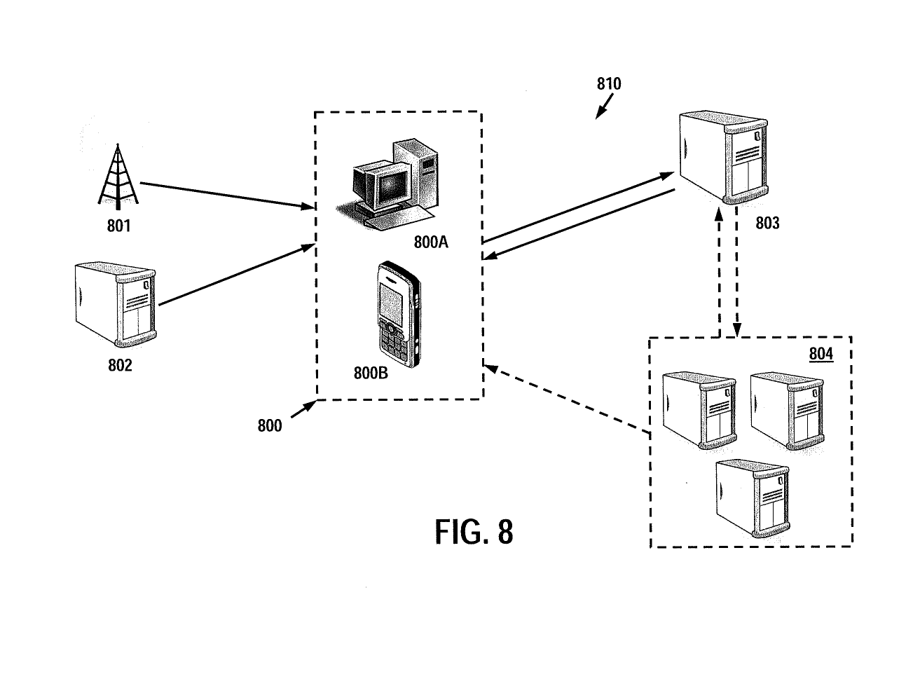

FIG. 8 illustrates an exemplary system 810 where a user device 800 may receive media received from a broadcast source 801 and/or a networked source 802. It is understood that other media formats are contemplated in this disclosure as well, including over-the-air, cable, satellite, network, internetwork (including the Internet), distributed on storage media, or by any other means or technique that is humanly perceptible, without regard to the form or content of such data, and including but not limited to audio, video, audio/video, text, images, animations, databases, broadcasts, and streaming media data. With regard to device 800, the example of FIG. 8 shows that the device 800 can be in the form of a stationary device 800A, such as a personal computer, and/or a portable device 800B, such as a cell phone (or laptop, tablet, etc.). Device 800 is communicatively coupled to server 803 via wired or wireless network. Server 803 may be communicatively coupled via wired or wireless connection to one or more additional servers 804, which may further communicate back to device 800.

As will be explained in further details below, device 800 captures ambient encoded audio through a microphone (not shown), preferably built in to device 800, and/or receives audio through a wired or wireless connection (e.g., 802.11 g, 802.11n, Bluetooth, etc.). The audio received in device may or may not be encoded. If encoded audio is received, it is decoded and a concurrent audio signature is formed using any of the techniques described above. After the encoded audio is decoded, one or more messages are detected and one or more signatures are extracted. Each message and/or signature may then used to trigger an action on device 800. Depending on the signature and/or content of the message(s), the process may result in the device (1) displaying an image, (2) displaying text, (2) displaying an HTML page, (3) playing video and/or audio, (4) executing software or a script, or any other similar function. The image may be a pre-stored digital image of any kind (e.g., JPEG) and may also be barcodes, QR Codes, and/or symbols for use with code readers found in kiosks, retail checkouts and security checkpoints in private and public locations. Additionally, the message or signature may trigger device 800 to connect to server 803, which would allow server 803 to provide data and information back to device 800, and/or connect to additional servers 804 in order to request and/or instruct them to provide data and information back to device 800.

In certain embodiments, a link, such as an IP address or Universal Resource Locator (URL), may be used as one of the messages. Under a preferred embodiment, shortened links may be used in order to reduce the size of the message and thus provide more efficient transmission. Using techniques such as URL shortening or redirection, this can be readily accomplished. In URL shortening, every “long” URL is associated with a unique key, which is the part after the top-level domain name. The redirection instruction sent to a browser can contain in its header the HTTP status 301 (permanent redirect) or 302 (temporary redirect). There are several techniques that may be used to implement a URL shortening. Keys can be generated in base 36, assuming 26 letters and 10 numbers. Alternatively, if uppercase and lowercase letters are differentiated, then each character can represent a single digit within a number of base 62. In order to form the key, a hash function can be made, or a random number generated so that key sequence is not predictable. The advantage of URL shortening is that most protocols are capable of being shortened (e.g., HTTP, HTTPS, FTP, FTPS, MMS, POP, etc.).

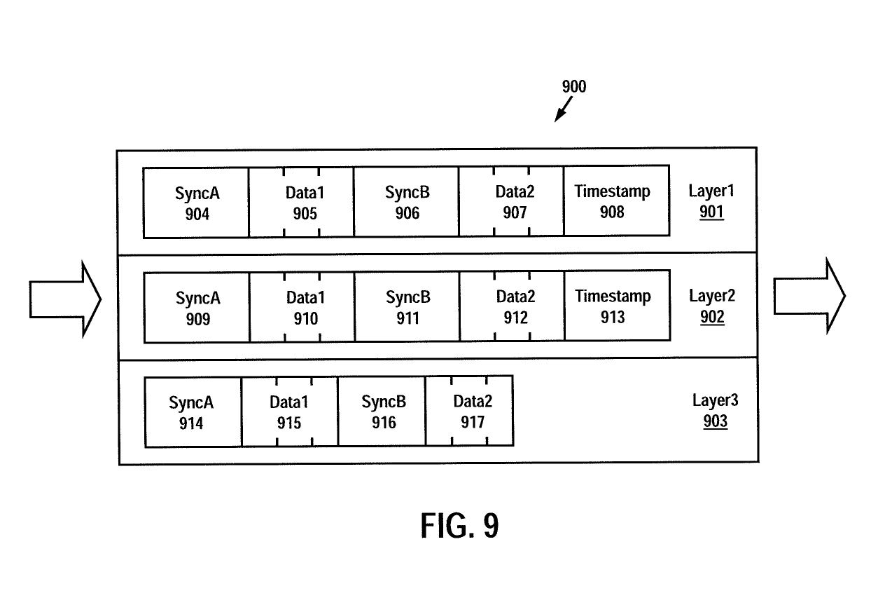

With regard to encoded audio, FIG. 9 illustrates a message 900 that may be embedded/encoded into an audio signal. In this embodiment, message 900 includes three layers that are inserted by encoders in a parallel format. Suitable encoding techniques are disclosed in U.S. Pat. No. 6,871,180, titled “Decoding of Information in Audio Signals,” issued Mar. 22, 2005, which is assigned to the assignee of the present application, and is incorporated by reference in its entirety herein. Other suitable techniques for encoding data in audio data are disclosed in U.S. Pat. Nos. 7,640,141 to Ronald S. Kolessar and 5,764,763 to James M. Jensen, et al., which are also assigned to the assignee of the present application, and which are incorporated by reference in their entirety herein. Other appropriate encoding techniques are disclosed in U.S. Pat. No. 5,579,124 to Aijala, et al., U.S. Pat. Nos. 5,574,962, 5,581,800 and 5,787,334 to Fardeau, et al., and U.S. Pat. No. 5,450,490 to Jensen, et al., each of which is assigned to the assignee of the present application and all of which are incorporated herein by reference in their entirety.

When utilizing a multi-layered message, one, two or three layers may be present in an encoded data stream, and each layer may be used to convey different data. Turning to FIG. 2, message 900 includes a first layer 901 containing a message comprising multiple message symbols. During the encoding process, a predefined set of audio tones (e.g., ten) or single frequency code components are added to the audio signal during a time slot for a respective message symbol. At the end of each message symbol time slot, a new set of code components is added to the audio signal to represent a new message symbol in the next message symbol time slot. At the end of such new time slot another set of code components may be added to the audio signal to represent still another message symbol, and so on during portions of the audio signal that are able to psychoacoustically mask the code components so they are inaudible. Preferably, the symbols of each message layer are selected from a unique symbol set. In layer 901, each symbol set includes two synchronization symbols (also referred to as marker symbols) 904, 906, a larger number of data symbols 905, 907, and time code symbols 908. Time code symbols 908 and data symbols 905, 907 are preferably configured as multiple-symbol groups.

The second layer 902 of message 900 is illustrated having a similar configuration to layer 901, where each symbol set includes two synchronization symbols 909, 911, a larger number of data symbols 910, 912, and time code symbols 913. The third layer 903 includes two synchronization symbols 914, 916, and a larger number of data symbols 915, 917. The data symbols in each symbol set for the layers (901-903) should preferably have a predefined order and be indexed (e.g., 1, 2, 3). The code components of each symbol in any of the symbol sets should preferably have selected frequencies that are different from the code components of every other symbol in the same symbol set. Under one embodiment, none of the code component frequencies used in representing the symbols of a message in one layer (e.g., Layer1 901) is used to represent any symbol of another layer (e.g., Layer2 902). In another embodiment, some of the code component frequencies used in representing symbols of messages in one layer (e.g., Layer3 903) may be used in representing symbols of messages in another layer (e.g., Layer1 901). However, in this embodiment, it is preferable that “shared” layers have differing formats (e.g., Layer3 903, Layer1 901) in order to assist the decoder in separately decoding the data contained therein.

Sequences of data symbols within a given layer are preferably configured so that each sequence is paired with the other and is separated by a predetermined offset. Thus, as an example, if data 905 contains code 1, 2, 3 having an offset of “2”, data 907 in layer 901 would be 3, 4, 5. Since the same information is represented by two different data symbols that are separated in time and have different frequency components (frequency content), the message may be diverse in both time and frequency. Such a configuration is particularly advantageous where interference would otherwise render data symbols undetectable. Under one embodiment, each of the symbols in a layer have a duration (e.g., 0.2-0.8 sec) that matches other layers (e.g., Layer1 901, Layer2 902). In another embodiment, the symbol duration may be different (e.g., Layer 2 902, Layer 3 903). During a decoding process, the decoder detects the layers and reports any predetermined segment that contains a code.

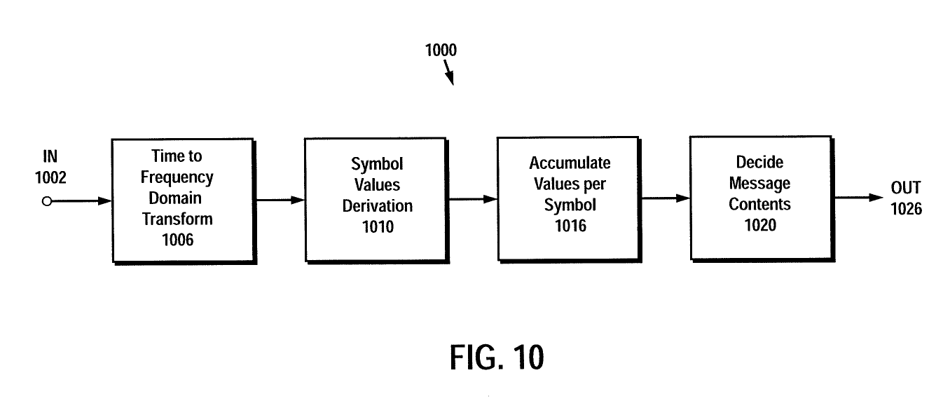

FIG. 10 is a functional block diagram illustrating a decoding apparatus under one embodiment. An audio signal which may be encoded as described hereinabove with a plurality of code symbols, is received at an input 1002. The received audio signal may be from streaming media, broadcast, otherwise communicated signal, or a signal reproduced from storage in a device. It may be a direct-coupled or an acoustically coupled signal. From the following description in connection with the accompanying drawings, it will be appreciated that decoder 1000 is capable of detecting codes in addition to those arranged in the formats disclosed hereinabove.

For received audio signals in the time domain, decoder 1000 transforms such signals to the frequency domain by means of function 1006. Function 1006 preferably is performed by a digital processor implementing a fast Fourier transform (FFT) although a direct cosine transform, a chirp transform or a Winograd transform algorithm (WFTA) may be employed in the alternative. Any other time-to-frequency-domain transformation function providing the necessary resolution may be employed in place of these. It will be appreciated that in certain implementations, function 306 may also be carried out by filters, by a application specific integrated circuit, or any other suitable device or combination of devices. Function 1006 may also be implemented by one or more devices which also implement one or more of the remaining functions illustrated in FIG. 10.

The frequency domain-converted audio signals are processed in a symbol values derivation function 1010, to produce a stream of symbol values for each code symbol included in the received audio signal. The produced symbol values may represent, for example, signal energy, power, sound pressure level, amplitude, etc., measured instantaneously or over a period of time, on an absolute or relative scale, and may be expressed as a single value or as multiple values. Where the symbols are encoded as groups of single frequency components each having a predetermined frequency, the symbol values preferably represent either single frequency component values or one or more values based on single frequency component values. Function 1010 may be carried out by a digital processor, such as a DSP which advantageously carries out some or all of the other functions of decoder 1000. However, the function 1010 may also be carried out by an application specific integrated circuit, or by any other suitable device or combination of devices, and may be implemented by apparatus apart from the means which implement the remaining functions of the decoder 1000.

The stream of symbol values produced by the function 1010 are accumulated over time in an appropriate storage device on a symbol-by-symbol basis, as indicated by function 1016. In particular, function 1016 is advantageous for use in decoding encoded symbols which repeat periodically, by periodically accumulating symbol values for the various possible symbols. For example, if a given symbol is expected to recur every X seconds, the function 1016 may serve to store a stream of symbol values for a period of nX seconds (n>1), and add to the stored values of one or more symbol value streams of nX seconds duration, so that peak symbol values accumulate over time, improving the signal-to-noise ratio of the stored values. Function 1016 may be carried out by a digital processor, such as a DSP, which advantageously carries out some or all of the other functions of decoder 1000. However, the function 1010 may also be carried out using a memory device separate from such a processor, or by an application specific integrated circuit, or by any other suitable device or combination of devices, and may be implemented by apparatus apart from the means which implements the remaining functions of the decoder 1000.

The accumulated symbol values stored by the function 1016 are then examined by the function 1020 to detect the presence of an encoded message and output the detected message at an output 1026. Function 1020 can be carried out by matching the stored accumulated values or a processed version of such values, against stored patterns, whether by correlation or by another pattern matching technique. However, function 1020 advantageously is carried out by examining peak accumulated symbol values and their relative timing, to reconstruct their encoded message. This function may be carried out after the first stream of symbol values has been stored by the function 1016 and/or after each subsequent stream has been added thereto, so that the message is detected once the signal-to-noise ratios of the stored, accumulated streams of symbol values reveal a valid message pattern.

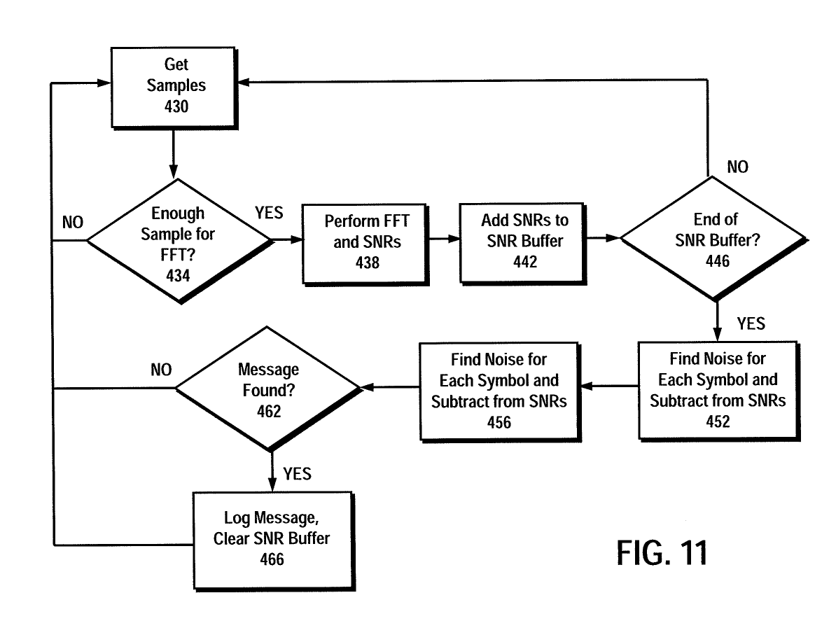

FIG. 11 is a flow chart for a decoder according to one advantageous embodiment of the invention implemented by means of a DSP. Step 430 is provided for those applications in which the encoded audio signal is received in analog form, for example, where it has been picked up by a microphone or an RF receiver. The decoder of FIG. 11 is particularly well adapted for detecting code symbols each of which includes a plurality of predetermined frequency components, e.g. ten components, within a frequency range of 1000 Hz to 3000 Hz. In this embodiment, the decoder is designed specifically to detect a message having a specific sequence wherein each symbol occupies a specified time interval (e.g., 0.5 sec). In this exemplary embodiment, it is assumed that the symbol set consists of twelve symbols, each having ten predetermined frequency components, none of which is shared with any other symbol of the symbol set. It will be appreciated that the FIG. 11 decoder may readily be modified to detect different numbers of code symbols, different numbers of components, different symbol sequences and symbol durations, as well as components arranged in different frequency bands.

In order to separate the various components, the DSP repeatedly carries out FFTs on audio signal samples falling within successive, predetermined intervals. The intervals may overlap, although this is not required. In an exemplary embodiment, ten overlapping FFT's are carried out during each second of decoder operation. Accordingly, the energy of each symbol period falls within five FFT periods. The FFT's are preferably windowed, although this may be omitted in order to simplify the decoder. The samples are stored and, when a sufficient number are thus available, a new FFT is performed, as indicated by steps 434 and 438.

In this embodiment, the frequency component values are produced on a relative basis. That is, each component value is represented as a signal-to-noise ratio (SNR), produced as follows. The energy within each frequency bin of the FFT in which a frequency component of any symbol can fall provides the numerator of each corresponding SNR Its denominator is determined as an average of adjacent bin values. For example, the average of seven of the eight surrounding bin energy values may be used, the largest value of the eight being ignored in order to avoid the influence of a possible large bin energy value which could result, for example, from an audio signal component in the neighborhood of the code frequency component. Also, given that a large energy value could also appear in the code component bin, for example, due to noise or an audio signal component, the SNR is appropriately limited. In this embodiment, if SNR>6.0, then SNR is limited to 6.0, although a different maximum value may be selected.

The ten SNR's of each FFT and corresponding to each symbol which may be present, are combined to form symbol SNR's which are stored in a circular symbol SNR buffer, as indicated in step 442. In certain embodiments, the ten SNR's for a symbol are simply added, although other ways of combining the SNR's may be employed. The symbol SNR's for each of the twelve symbols are stored in the symbol SNR buffer as separate sequences, one symbol SNR for each FFT for 50 μl FFT's. After the values produced in the 50 FFT's have been stored in the symbol SNR buffer, new symbol SNR's are combined with the previously stored values, as described below.

When the symbol SNR buffer is filled, this is detected in a step 446. In certain advantageous embodiments, the stored SNR's are adjusted to reduce the influence of noise in a step 452, although this step may be optional. In this optional step, a noise value is obtained for each symbol (row) in the buffer by obtaining the average of all stored symbol SNR's in the respective row each time the buffer is filled. Then, to compensate for the effects of noise, this average or “noise” value is subtracted from each of the stored symbol SNR values in the corresponding row. In this manner, a “symbol” appearing only briefly, and thus not a valid detection, is averaged out over time.

After the symbol SNR's have been adjusted by subtracting the noise level, the decoder attempts to recover the message by examining the pattern of maximum SNR values in the buffer in a step 456. In certain embodiments, the maximum SNR values for each symbol are located in a process of successively combining groups of five adjacent SNR's, by weighting the values in the sequence in proportion to the sequential weighting (6 10 10 10 6) and then adding the weighted SNR's to produce a comparison SNR centered in the time period of the third SNR in the sequence. This process is carried out progressively throughout the fifty FFT periods of each symbol. For example, a first group of five SNR's for a specific symbol in FFT time periods (e.g., 1-5) are weighted and added to produce a comparison SNR for a specific FFT period (e.g., 3). Then a further comparison SNR is produced using the SNR's from successive FFT periods (e.g., 2-6), and so on until comparison values have been obtained centered on all FFT periods. However, other means may be employed for recovering the message. For example, either more or less than five SNR's may be combined, they may be combined without weighing, or they may be combined in a non-linear fashion.

After the comparison SNR values have been obtained, the decoder examines the comparison SNR values for a message pattern. Under a preferred embodiment, the synchronization (“marker”) code symbols are located first. Once this information is obtained, the decoder attempts to detect the peaks of the data symbols. The use of a predetermined offset between each data symbol in the first segment and the corresponding data symbol in the second segment provides a check on the validity of the detected message. That is, if both markers are detected and the same offset is observed between each data symbol in the first segment and its corresponding data symbol in the second segment, it is highly likely that a valid message has been received. If this is the case, the message is logged, and the SNR buffer is cleared 466. It is understood by those skilled in the art that decoder operation may be modified depending on the structure of the message, its timing, its signal path, the mode of its detection, etc., without departing from the scope of the present invention. For example, in place of storing SNR's, FFT results may be stored directly for detecting a message.

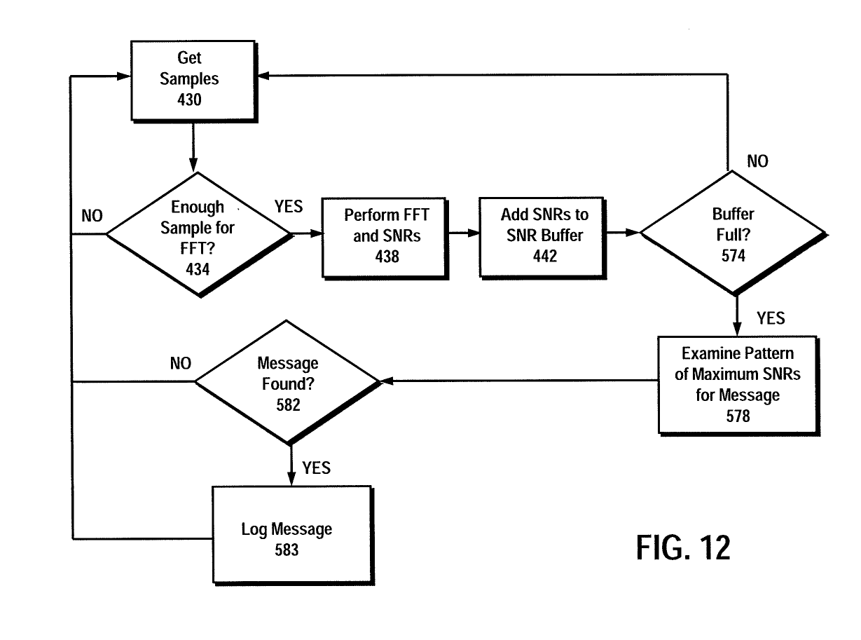

FIG. 12 is a flow chart for another decoder according to a further advantageous embodiment likewise implemented by means of a DSP. The decoder of FIG. 12 is especially adapted to detect a repeating sequence of code symbols (e.g., 5 code symbols) consisting of a marker symbol followed by a plurality (e.g., 4) data symbols wherein each of the code symbols includes a plurality of predetermined frequency components and has a predetermined duration (e.g., 0.5 sec) in the message sequence. It is assumed in this example that each symbol is represented by ten unique frequency components and that the symbol set includes twelve different symbols. It is understood that this embodiment may readily be modified to detect any number of symbols, each represented by one or more frequency components.

Steps employed in the decoding process illustrated in FIG. 12 which correspond to those of FIG. 4 are indicated by the same reference numerals, and these steps consequently are not further described. The FIG. 12 embodiment uses a circular buffer which is twelve symbols wide by 150 FFT periods long. Once the buffer has been filled, new symbol SNRs each replace what are than the oldest symbol SNR values. In effect, the buffer stores a fifteen second window of symbol SNR values. As indicated in step 574, once the circular buffer is filled, its contents are examined in a step 578 to detect the presence of the message pattern. Once full, the buffer remains full continuously, so that the pattern search of step 578 may be carried out after every FFT.

Since each five symbol message repeats every 2½ seconds, each symbol repeats at intervals of 2½ seconds or every 25 FFT's. In order to compensate for the effects of burst errors and the like, the SNR's R1 through R150 are combined by adding corresponding values of the repeating messages to obtain 25 combined SNR values SNRn, n=1,2 . . . 25, as follows:

$${SNR}_{n} = {\sum }_{i = 0}^{5} {R}_{n + 25 i}$$

Accordingly, if a burst error should result in the loss of a signal interval i, only one of the six message intervals will have been lost, and the essential characteristics of the combined SNR values are likely to be unaffected by this event.

Once the combined SNR values have been determined, the decoder detects the position of the marker symbol's peak as indicated by the combined SNR values and derives the data symbol sequence based on the marker's position and the peak values of the data symbols. Once the message has thus been formed, as indicated in steps 582 and 583, the message is logged. However, unlike the embodiment of FIG. 4 the buffer is not cleared. Instead, the decoder loads a further set of SNR's in the buffer and continues to search for a message.

As in the decoder of FIG. 11, it will be apparent from the foregoing to modify the decoder of FIG. 12 for different message structures, message timings, signal paths, detection modes, etc., without departing from the scope of the present invention. For example, the buffer of the FIG. 12 embodiment may be replaced by any other suitable storage device; the size of the buffer may be varied; the size of the SNR values windows may be varied; and/or the symbol repetition time may vary. Also, instead of calculating and storing signal SNR's to represent the respective symbol values, a measure of each symbol's value relative to the other possible symbols, for example, a ranking of each possible symbol's magnitude, is instead used in certain advantageous embodiments.

In a further variation which is especially useful in audience measurement applications, a relatively large number of message intervals are separately stored to permit a retrospective analysis of their contents to detect a channel change. In another embodiment, multiple buffers are employed, each accumulating data for a different number of intervals for use in the decoding method of FIG. 12. For example, one buffer could store a single message interval, another two accumulated intervals, a third four intervals and a fourth eight intervals. Separate detections based on the contents of each buffer are then used to detect a channel change.

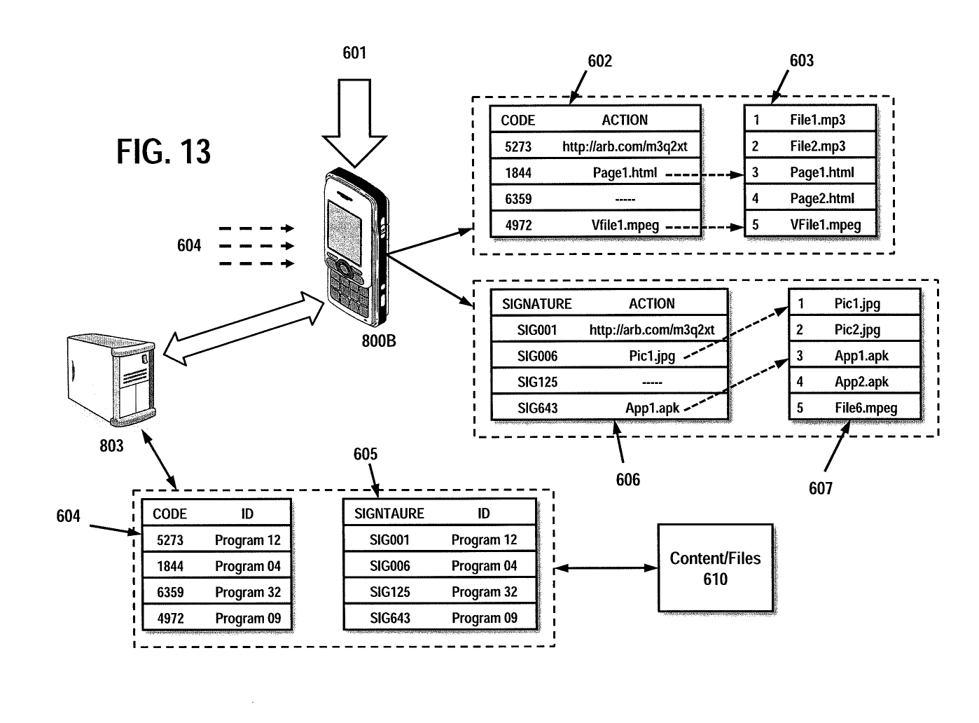

Turning to FIG. 13, an exemplary embodiment is illustrated, where a cell phone 800B receives audio 604 either through a microphone or through a data connection (e.g., WiFi). It is understood that, while the embodiment of FIG. 13 is described in connection with a cell phone, other devices, such as PC's tablet computers and the like, are contemplated as well. Under one embodiment, supplementary research data (601) is “pushed” to phone 100B, and may include information such as a code/action table 602 and related supplementary content 603. Additionally, supplementary data 601 may include a signature/action table 606 and related supplementary content 607. The content is preferably pushed at predetermined times (e.g., once a day at 8:00 AM) and resides on phone 800B for a limited time period, or until a specific event occurs. In an alternate embodiment, supplementary research data 601 may be retrieved from a network source.

Given that accumulated supplementary data on a device is generally undesirable, it is preferred that pushed content be erased from the device to avoid excessive memory usage. Under one example, content (603, 607) would be pushed to cell phone 800B and would reside in the phone's memory until the next “push” is received. When the content from the second push is stored, the content from the previous push is erased. An erase command (and/or other commands) may be contained in the pushed data, or may be contained in data decoded from audio. Under another embodiment, multiple content pushes may be stored, and the phone may be configured to keep a predetermined amount of pushed content (e.g., seven consecutive days). Under yet another embodiment, cell phone 800B may be enabled with a protection function to allow a user to permanently store selected content that was pushed to the device. Such a configuration is particularly advantageous if a user wishes to keep the content and prevent it from being automatically deleted. Cell phone 800B may even be configures to allow a user to protect content over time increments (e.g., selecting “save today's content”).

Referring to FIG. 13, pushed content 601 comprises code/action table 602, that includes one or more codes (5273, 1844, 6359, 4972) and an associated action. Here, the action may be the execution of a link, display of a HTML page, playing of multimedia, or the like. As audio is decoded using any of the techniques described above, one or more messages are formed on device 800B. Since the messages may be distributed over multiple layers, a received message may include identification data pertaining to the received audio, along with a code, and possibly other data.

Each respective code may be associated with a particular action. In the example of FIG. 13, code “5273” is associated with a linking action, which in this case is a shortened URL (http://arb.com/m3q2xt). The link is used to automatically connect device 800B to a network. Detected code “1844” is associated with HTML page “Page1.html” which may be retrieved on the device from the pushed content 603 (item 3). Detected code “6359” is not associated with any action, while detected code “4972” is associated with playing video file “VFile1.mpg” which is retrieved from pushed content 603 (item 5). As each code is detected, it is processed using 602 to determine if an action should be taken. In some cases, an action is triggered, but in other cases, no action is taken. In any event, the detected codes are separately transmitted via wireless or wired connection to server 103, which processes code 604 to produce research data that identifies the content received on device 800B.

Utilizing encoding/decoding techniques disclosed herein, more complex arrangements can be made for incorporating supplementary data into the encoded audio. For example, multimedia identification codes can be embedded in one layer, while supplementary data (e.g., URL link) can be embedded in a second layer. Execution/activation instruction codes may be embedded in a third layer, and so on. Multi-layer messages may also be interspersed between or among media identification messages to allow customized delivery of supplementary data according to a specific schedule.

In addition to code/action table 602, a signature/action table 606 may be pushed to device 800B as well. It is understood by those skilled in the art that signature table 606 may be pushed together with code table 602, or separately at different times. Signature table 606 similarly contains action items associated with at least one signature. As illustrated in FIG. 13, a first signature SIG001 is associated with a linking action, which in this case is a shortened URL (http://arb.com/m3q2xt). The link is used to automatically connect device 800B to a network. Signature SIG006 is associated with a digital picture “Pic1.jpg” which may be retrieved on the device from the pushed content 607 (item 1). Signature SIG125 is not associated with any action, while signature SIG643 is associated with activating software application “App1.apk” which accessed from pushed content 607 (item 3), or may be also may be residing as a native application on device 800B. As each signature is extracted, it is processed using 606 to determine if an action should be taken. In some cases, an action is triggered, but in other cases, no action is taken. Since audio signatures are transitory in nature, in a preferred embodiment, multiple signatures are associated with a single action. Thus, as an example, if device 800B is extracting signatures from the audio of a commercial, the configuration may be such that the plurality of signatures extracted from the commercial are associated with a single action on device 800B. This configuration is particularly advantageous in properly executing an action when signatures are being extracted in a noisy environment. In any event, the extracted signatures are transmitted via wireless or wired connection to server 103, which processes signatures 605 to produce research data that identifies the content received on device 800B.

In addition to performing actions on the device, the codes and signatures transmitted from device 800B may be processed remotely in server 803 to determine personalized content and/or files 610 that may be transmitted back to device 800B. More specifically, content identified from any of 604 and/or 605 may be processed and alternately correlated with demographic data relating to the user of device 800B to generate personalized content, software, etc. that is presented to user of device 800B. These processes may be performed on server 803 alone, or together with other servers or in a “cloud.”

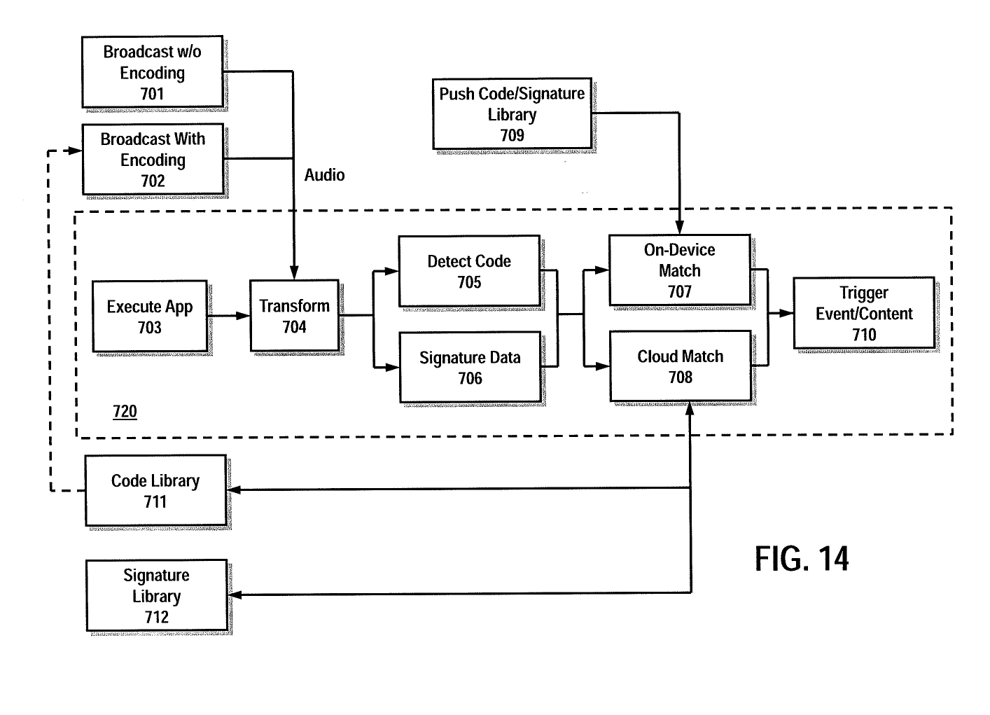

Turning now to FIG. 14, an exemplary process flow is illustrated for device 720, which, under one embodiment, executes a metering software application 703, allowing it to detect audio codes and extract signatures. Device 720 receives audio from media that may be encoded 701 or not 702. Codes used for embedded audio are preferably provided by a dedicated code library 711, where the codes are encoded at the point of transmission or broadcast. When media is received in device 720, a transform 704 is performed on the audio, where codes may be detected 705 and signature data may be extracted 706 as a result of the transform. Under one advantageous embodiment, if no code is present in the audio, the transform produces a plurality of signatures that are subsequently transmitted remotely for processing (803). However, if code is detected, the extracted signature data is discarded. Such an arrangement can serve to preserve resources if memory and/or processing power is limited.

Under another advantageous embodiment, the concurrently extracted signatures may be used to supplement the code data that is detected. As discussed above in connection with FIG. 9, code messages may contain information embedded into multiple layers. This means that information decoded from a message may contain a minimum of information, i.e., data detected only from one layer, a maximum of information, i.e., data detected from all layers, or something in-between. In certain cases, broadcasters or other content providers will purposefully encode media using data that utilizes less than the maximum amount of information allowed. In other cases, noise or interference may affect the decoding process to a point where the full amount of data contained in the message is not detected. In either case, device 720 may be configured to look for codes having a particular characteristic. The characteristic may be a code format, size, or specific data that should be present in the message. If the detected code matches this characteristic, the signature data is discarded to preserve resources. However, if the detected code does not match the characteristic, this signals a potential deficiency in the code data. As such, the signature data is not discarded, but is processed to form signatures that are transmitted together with the detected codes for remote processing. At the remote processing site (e.g., 803) the results of the signature processing may be used to “fill in” the information that was missing or not detected in the code.

Continuing with the embodiment of FIG. 14, after the codes and/or signatures are collected, device 720 has the option of matching the codes/signatures on the device itself 707 (see, FIG. 13, refs. 602-603, 606-607) or transmit the codes/signatures remotely 708. If a match is performed on device 720, the match is made against a code/signature library 709 that was previously pushed to device 720, much like the embodiment discussed above in FIG. 13. Detected matches trigger an action 710 to be performed on device 720, such as the presentation of content, activation of software, etc. If a match is performed remotely, codes are compared to code library 711, while signatures are compared to signature library 712, both of which may reside in one or more networked servers (e.g., 803). Matches in this case are made on the server(s), where the results of the matches are processed and used to obtain personalized content, software, etc. (see 610) that may be transmitted back to device 720.

In an alternate embodiment, content, software, etc. obtained from the remote processing is not only transmitted to device 720, but is also transmitted to other devices registered by the user of device 720. Additionally, the content, software, etc. does not have to occur in real-time, but may be performed at pre-determined times, or upon the detection of an event (e.g., device 720 is being charged or is idle). Furthermore, using a suitably-configured device, detection of certain codes/signatures may be used to affect or enhance performance of device 720. For example, detection of certain codes/signatures may unlock features on the device or enhance connectivity to a network. Moreover, actions performed as a result of media exposure detection can be used to control and/or configure other devices that are otherwise unrelated to media. For example, one exemplary action may include the transmission of a control signal to a device, such as a light dimmer, to dim the room lights when a particular program is detected. It is appreciated by those skilled in the art that a multitude of options are available using the techniques described herein.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented method for a device configured to receive multimedia, comprising:
performing a transformation on a portion of the multimedia in the device, wherein the transformation detects ancillary code and extracts at least one signature from the portion; and
performing an action as a result of the transformation, wherein the action comprises one of (a) presenting supplementary data on the device, and (b) executing software, wherein the action is determined from at least one of the ancillary code and extracted signature.

2. The computer-implemented method of claim 1, wherein the ancillary code comprises a plurality of code symbols arranged in a plurality of layers.

3. The computer-implemented method of claim 1, wherein the supplementary data comprises one of video, audio, images, HyperText Markup Language (HTML) content, a Uniform Resource Locator (URL), a shortened URL, metadata, and text.

4. The computer-implemented method of claim 3, wherein the presented supplementary data is accessed on the device.

5. The computer-implemented method of claim 3, wherein the presented supplementary data is accessed from a network.

6. The computer-implemented method of claim 1, wherein the transformation comprises converting audio of the multimedia from a time domain to a frequency domain.

7. The computer-implemented method of claim 1, wherein the device comprises one of a cell phone, smart phone, personal digital assistant, personal computer, portable computer, television, set-top box, and media box.

8. An apparatus comprising:
an interface for receiving multimedia on a device, wherein the multimedia comprises audio; and
a processing apparatus, coupled to the interface, for performing a transformation on a portion of the multimedia in the device, wherein the transformation detects ancillary code and extracts at least one signature from the portion, wherein the processor is configured to direct the performance of an action, wherein the action comprises one of (a) presenting supplementary data on the device, and (b) executing software, wherein the action is determined from at least one of the ancillary code and extracted signature.

9. The apparatus of claim 8, wherein the processing apparatus comprises a decoder for decoding ancillary code from an audio portion of the multimedia, said ancillary code comprising a plurality of code symbols arranged concurrently in a plurality of layers in the audio portion.

10. The apparatus according to claim 8, wherein the supplementary data comprises one of video, audio, images, HyperText Markup Language (HTML) content, a Uniform Resource Locator (URL), a shortened URL, metadata, and text.

11. The apparatus according to claim 8, further comprising a storage, wherein at least one of (a) the presented supplementary data and (b) executed software, is accessed from the storage.

12. The apparatus according to claim 8, wherein the presented supplementary data is accessed from a network via the interface.

13. The apparatus according to claim 8, wherein the apparatus comprises one of a cell phone, smart phone, personal digital assistant, personal computer, portable computer, television, set-top box, and media box.

14. The apparatus according to claim 9, wherein the decoder performs a transformation on the audio portion for decoding the ancillary code, and wherein the processor extracts the at least one signature using features of the audio.

15. A computer-implemented method for a device configured to receive multimedia, comprising:
performing a transformation on a portion of the multimedia in the device, wherein the transformation concurrently detects ancillary code and extracts at least one signature from the portion, each of the ancillary code and signature being configured to identify a characteristic of the received multimedia;
performing a type of action, wherein the action type is determined from at least one of the ancillary code and extracted signature, and wherein the action type comprises one of (a) presenting supplementary data on the device, and (b) executing software on the device.

16. The computer-implemented method of claim 15, wherein the ancillary code comprises a plurality of code symbols arranged in a plurality of layers.

17. The computer-implemented method according to claim 15, wherein the supplementary data comprises one of video, audio, images, HyperText Markup Language (HTML) content, a Uniform Resource Locator (URL), a shortened URL, metadata, and text.

18. The computer-implemented method according to claim 17, wherein the presented supplementary data is accessed from one of (1) the device, and (2) a network.

19. The computer-implemented method according to claim 15, wherein the device comprises one of a cell phone, smart phone, personal digital assistant, personal computer, portable computer, television, set-top box, and media box.

20. The computer-implemented method according to claim 15, wherein the signature is extracted using features of the audio.
